(19) United States
(12) Patent Application Publication
(10) Pub. No.: US 2020/0237479 A1
(43) Pub. Date: Jul. 30, 2020

(54) SHELL-SHAPED DENTAL APPLIANCE AND ITS SHELL-SHAPED BODY

(71) Applicant: WUXI EA MEDICAL INSTRUMENTS TECHNOLOGIES LIMITED, Wuxi City, Jiangsu (CN)

(72) Inventors: Ketuo ZHOU, Shanghai (CN); Lei HUANG, Shanghai (CN)

(73) Assignee: WUXI EA MEDICAL INSTRUMENTS TECHNOLOGIES LIMITED, Wuxi City, Jiangsu (CN)

(21) Appl. No.: 16/652,658

(22) PCT Filed: Jan. 8, 2019
(86) PCT No.: PCT/CN2019/070801

§ 371 Date: Mar. 31, 2020

(30) Foreign Application Priority Data
Mar. 16, 2018 (CN) 201820368132.3

(51) Int. Cl. A61C 7/08; A61C 7/36

(52) U.S. Cl. CPC A61C 7/08; A61C 7/36

(57) ABSTRACT

The present application provides a shell-shaped body of a shell-shaped dental appliance, the shell-shaped body is a one-piece shell and forms a cavity for receiving a plurality of teeth and a first accessory mounting area, where the contour of the outer surface of the first accessory mounting area has a standard geometry for mounting a first accessory having a standard mounting surface, where the contour of the outer surface of the first accessory mounting area substantially matches that of the standard mounting surface of the first accessory.

### FIELD OF THE APPLICATION

The present application generally relates to a shell-shaped dental appliance, and more specifically to a shell-shaped dental appliance mounted with a standard accessory and its shell-shaped body.

### BACKGROUND

Due to advantages on appearance, convenience and hygiene etc., shell-shaped dental appliances (e.g., invisible tooth repositioner and retainer) made of polymer materials become more and more popular. A conventional shell-shaped dental appliance is usually a one-piece shell which forms a cavity for receiving a plurality of teeth, and the geometry of the cavity substantially matches a corresponding teeth arrangement.

When a shell-shaped dental appliance is used for a dental treatment (e.g., orthodontic treatment or orthognathic treatment), sometimes an accessory such as Twin-Block, Bracket, Button, Bite Stop and Occlusal Pad etc. needs to be mounted on the shell-shaped dental appliance to aid in the treatment.

In some cases, accessories may be manufactured separately, and mounted on the shell-shaped dental appliance by adhesion, welding, mechanical connection etc.

In some examples, accessories are standard parts having a mounting surface with a predetermined standard geometry. However, the geometry of the outer surface of a shell-shaped dental appliance is substantially highly correlated with the geometry of the teeth. Therefore, the geometries of engagement surfaces of the accessory and the shell-shaped dental appliance probably do not match, which affects the bonding strength between the accessory and the shell-shaped dental appliance.

In some other examples, an accessory is a non-standard part, and it is such fabricated that the geometry of its mounting surface matches the geometry of the area on the shell-shaped dental appliance where it is to be mounted. However, this increases the complexity of the manufacture of accessories and decreases universality of the same.

In view of the above, it is necessary to provide a new shell-shaped dental appliance.

### SUMMARY

In one aspect, the present application provides a shell-shaped body of a shell-shaped dental appliance, the shell-shaped body is a one-piece shell, and forms a cavity for receiving a plurality of teeth and a first accessory mounting area, the contour of the outer surface of which has a standard geometry, for mounting a first accessory having a standard mounting surface, where the contour of the outer surface of the first accessory mounting area substantially matches that of the standard mounting surface of the first accessory.

In some embodiments, the contour of the outer surface of the first accessory mounting area may be one of a plane and a revolved surface.

In some embodiments, the whole first accessory mounting area may protrude outwards.

In some embodiments, the geometry of the shell-shaped boy is such that when it is worn on the plurality of teeth under a corresponding tooth arrangement, the inner surface of the first accessory mounting area is not in contact with the teeth.

In some embodiments, the first accessory may be an independent element.

In some embodiments, the first accessory may be one of an occlusal pad, a button, a bracket, a bite stop and a twin-block.

In some embodiments, the outer surface of the first accessory mounting area is a surface opposite to the cavity for receiving the plurality of teeth.

In some embodiments, the first accessory mounting area may be for mounting the first accessory by adhesion.

In some embodiments, the matching rate between the contours of the outer surface of the first accessory mounting area and the standard mounting surface of the first accessory satisfies attachment by adhesion.

In some embodiments, the outer surface of the first accessory mounting area has a wider coverage than the standard mounting surface of the first accessory.

In some embodiments, a structure capable of enhancing bonding strength may be formed on one of the outer surface of the first accessory mounting area and the standard mounting surface of the first accessory.

In some embodiments, except for the first accessory mounting area, the geometry of the cavity for receiving the plurality of teeth may substantially match the plurality of teeth under a corresponding tooth arrangement.

In another aspect, the present application provides a shell-shaped dental appliance which comprises: a shell-shaped body which is a one-piece shell and forms a cavity for receiving a plurality of teeth and a first accessory mounting area; and a first accessory which forms a standard mounting surface; where the contour of the outer surface of the first accessory mounting area substantially matches that of the standard mounting surface of the first accessory, and the first accessory is mounted on the shell-shaped body by bonding the outer surface of the first accessory mounting area and the standard mounting surface.

In some embodiments, the contour of the outer surface of the first accessory mounting area may be one of a plane and a revolved surface.

In some embodiments, the whole first accessory mounting area may protrude outwards.

In some embodiments, the geometry of the shell-shaped body is such that when it is worn on the plurality of teeth under a corresponding tooth arrangement, the inner surface of the first accessory mounting area is not in contact with the teeth.

In some embodiments, the first accessory may be one of an occlusal pad, a button, a bracket, a bite stop and a twin-block.

In some embodiments, the outer surface of the first accessory mounting area is a surface opposite to the cavity for receiving the plurality of teeth.

In some embodiments, the first accessory may be mounted on the outer surface of the first accessory mounting area by adhesion.

In some embodiments, the matching rate between the contours of the outer surface of the first accessory mounting area and the standard mounting surface of the first accessory satisfies attachment by adhesion.

In some embodiments, the outer surface of the first accessory mounting area has a wider coverage than the standard mounting surface of the first accessory.

In some embodiments, a structure capable of enhancing bonding strength may be formed on one of the outer surface of the first accessory mounting area and the standard mounting surface of the first accessory.

In some embodiments, except for the first accessory mounting area, the geometry of the cavity for receiving the plurality of teeth may substantially match the plurality of teeth under a corresponding tooth arrangement.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the protection scope of the present application. Unless otherwise specified, the figures are not necessarily drawn to scale, and similar reference numbers therein denote similar components.

FIG. 1A schematically illustrates a shell-shaped dental appliance according to one embodiment of the present application;

FIG. 1B schematically illustrates a shell-shaped body of the shell-shaped dental appliance shown in FIG. 1A;

FIG. 1C schematically illustrates a cross-sectional view of the shell-shaped body shown in FIG. 1B taken along line A-A;

FIG. 2 schematically illustrates a shell-shaped dental appliance according to another embodiment of the present application;

FIG. 3 schematically illustrates a shell-shaped dental appliance according to a further embodiment of the present application;

FIG. 4A schematically illustrates the engagement of the outer surface of an accessory mounting area and an accessory standard mounting surface according to one embodiment of the present application;

FIG. 4B schematically illustrates the engagement of the outer surface of an accessory mounting area and an accessory standard mounting surface according to another embodiment of the present application;

FIG. 4C schematically illustrates the engagement of the outer surface of an accessory mounting area and an accessory standard mounting surface according to a further embodiment of the present application;

FIG. 4D schematically illustrates the engagement of the outer surface of an accessory mounting area and an accessory standard mounting surface according to a further embodiment of the present application.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

In view of the above problems of the conventional shell-shaped dental appliance, the Inventors of the present application has developed a new shell-shaped dental appliance and its shell-shaped body after extensive research.

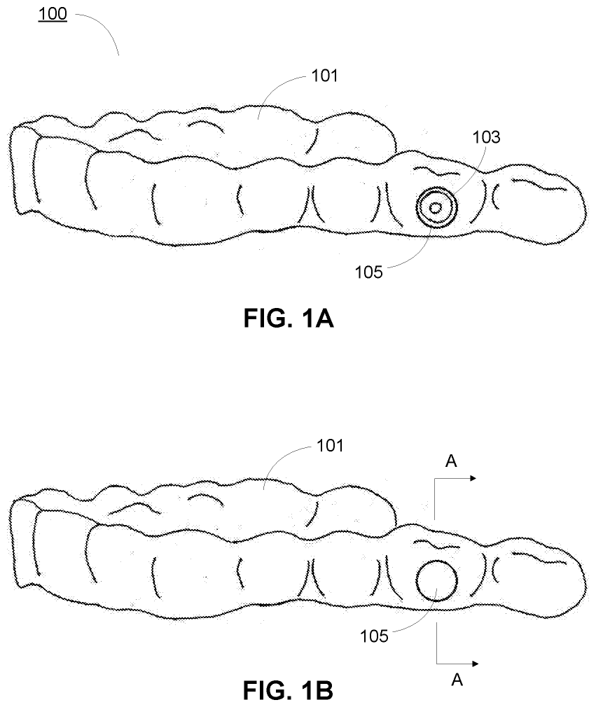

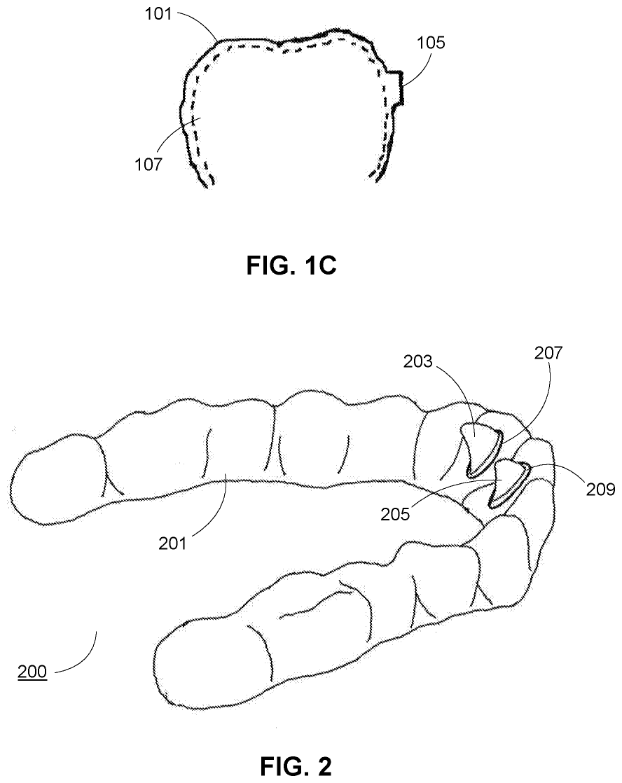

Referring to FIG. 1A, it schematically illustrates a shell-shaped dental appliance 100 according to one embodiment of the present application.

The shell-shaped dental appliance 100 comprises a shell-shaped body 101 and a button 103 fixed on the outer surface of the shell-shaped body 101, where an accessory mounting area 105 is formed on the shell-shaped body 101, and the contour of the outer surface of the accessory mounting area 105 has a standard geometry which substantially matches the contour of a standard mounting surface on the bottom of the button 103, so that the button 103 can be fixed on the shell-shaped body 101 by bonding the outer surface of the mounting area 105 and the standard mounting surface of the button 103.

In some embodiments, an elastic element (e.g., a rubber band or a spring) may be coupled to shell-shaped dental appliances worn on the upper jaw and the lower jaw respectively via buttons, to generate a force of traction therebetween, thereby implementing adjustment of the position of the lower jaw.

In some embodiments, the button 103 may be fixed on the shell-shaped body 101 by adhesion or welding.

Referring to FIG. 1B, it schematically illustrates the shell-shaped body 101 of the shell-shaped dental appliance 100 shown in FIG. 1A.

The outline of the accessory mounting area 105 is circular. Inspired by the present application, it is understood that the outline of the accessory mounting area 105 may also be in other shapes, for example, rectangle, ellipse, polygon etc.

Referring to FIG. 1C, it schematically illustrates a cross-sectional view of the shell-shaped body 101 shown in FIG. 1B taken along line A-A.

The shell-shaped body 101 forms a cavity 107 for receiving teeth, where except for the accessory mounting area 105, the geometry of the cavity 107 substantially matches the teeth under a corresponding tooth arrangement. For example, if the shell-shaped dental appliance 100 is an orthodontic repositioner, the geometry of the cavity 107 matches a target tooth arrangement of a corresponding treatment step.

In one embodiment, the whole accessory mounting area 105 protrudes outwards. When the shell-shaped dental appliance 100 is worn on the teeth, the inner surface of the accessory mounting area 105 is not in contact with the teeth (outlined by the dotted line).

Referring to FIG. 2, it schematically illustrates a shell-shaped dental appliance 200 according to another embodiment of the present application.

The shell-shaped dental appliance 200 comprises a shell-shaped body 201 and bite stops 203 and 205 fixed on the outer surface of the shell-shaped body 201, where accessory mounting areas 207 and 209 are formed on the shell-shaped body 201, and the contour of the outer surfaces of the accessory mounting areas 207 and 209 has a standard geometry which substantially matches that of the contour of the standard mounting surfaces of the bite stops 203 and 205, so that the bite stops 203 and 205 can be respectively fixed on the outer surfaces of the mounting areas 207 and 209 by bonding their standard mounting surfaces with the same.

The shell-shaped dental appliance 200 may be used to open occlusion for an “anterior crossbite” case. When the shell-shaped dental appliance 200 is worn on the teeth, anterior teeth of the opposite jaw will abut against an end of the bite stops 203 and 205 adjacent to the cutting ends of the teeth, thereby opening the occlusion.

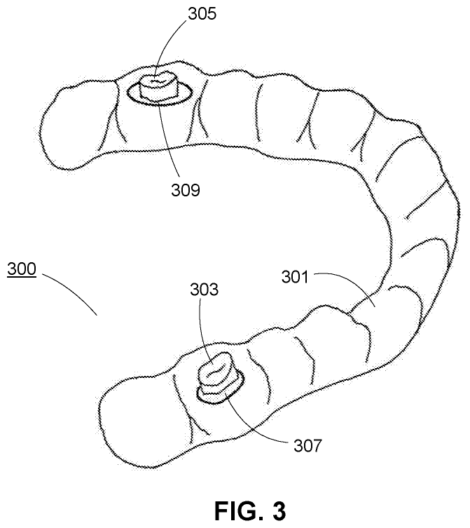

Referring to FIG. 3, it schematically illustrates a shell-shaped dental appliance 300 according to a further embodiment of the present application.

The shell-shaped dental appliance 300 comprises a shell-shaped body 301 and occlusal pads 303 and 305 fixed on the outer surface of posterior areas of both sides of the shell-shaped body 301, where accessory mounting areas 307 and 309 are respectively formed in the posterior areas of both sides of the shell-shaped body 301, and the contours of the outer surfaces of the accessory mounting areas 307 and 309 have a standard geometry which substantially matches the contours of the standard mounting surfaces of the occlusal pads 303 and 305, so that the occlusal pads 303 and 305 can be respectively fixed on the outer surfaces of the mounting areas 307 and 309 by bonding their standard mounting surfaces with the same.

When the shell-shaped dental appliance 300 is worn on the teeth, posterior teeth of the opposite jaw will abut against the occlusal pads 303 and 305, thereby opening the occlusion.

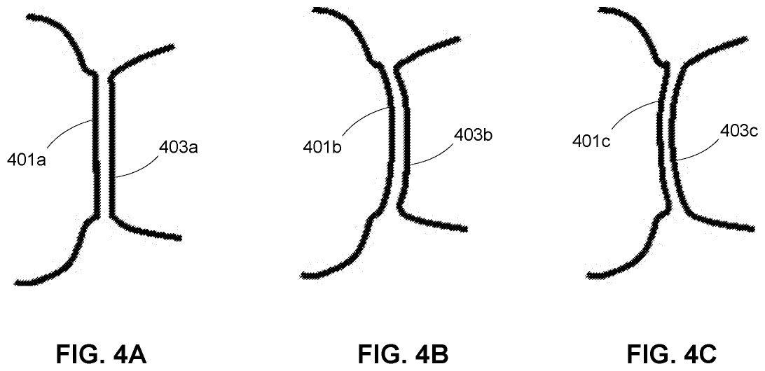

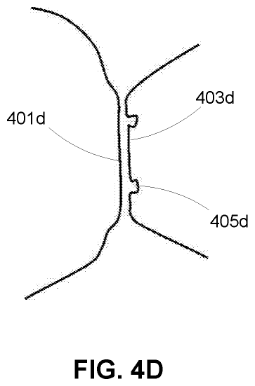

Referring to FIG. 4A, it schematically illustrates the engagement of the outer surface 401a of an accessory mounting area and an accessory standard mounting surface 403a according to one embodiment of the present application. In this embodiment, both the outer surface 401a of the accessory mounting area and the accessory standard mounting surface 403a are planes.

Referring to FIG. 4B, it schematically illustrates the engagement of the outer surface 401b of an accessory mounting area and an accessory standard mounting surface 403b according to one embodiment of the present application. In this embodiment, the outer surface 401b of the accessory mounting area is a convex arc surface, and the accessory standard mounting surface 403b is a concave arc surface matching with the convex arc surface.

Referring to FIG. 4C, it schematically illustrates the engagement of the outer surface 401c of an accessory mounting area and an accessory standard mounting surface 403c according to one embodiment of the present application. In this embodiment, the outer surface 401c of the accessory mounting area is a concave arc surface, and the accessory standard mounting surface 403c is a convex arc surface matching with the concave arc surface.

Referring to FIG. 4D, it schematically illustrates the engagement of the outer surface 401d of an accessory mounting area and an accessory standard mounting surface 403d according to one embodiment of the present application. In this embodiment, the outer surface 401d of the mounting area is a plane, and the contour of the accessory standard mounting surface 403d is a plane on which a groove 405d for receiving an adhesive is formed. When the adhesive is used to bond the accessory to the accessory mounting area, the groove 405d can receive the adhesive. This can prevent the adhesive from overflowing to a certain degree on the one hand, and can enhance the bonding strength on the other hand.

Inspired by the present application, it is understood that to enhance bonding strength, a shape such as dots or stripes may be formed on at least one of the outer surface of the accessory mounting area and the accessory standard mounting surface.

In some embodiments, area of at least one of the outer surface of the accessory mounting area and the accessory standard mounting surface is greater than that of the other. So, when adhesive is used to fix the accessory, excess adhesive can cover the edge of the one with a smaller area, and enhance the bonding strength. In one embodiment, the area of the outer surface of the accessory mounting area is greater than that of the accessory standard mounting surface, or put it another way, after the accessory is fixed on the shell-shaped body, the coverage of the outer surface of the accessory mounting area exceeds the accessory standard mounting surface.

In some embodiments, the contours of the outer surface of the accessory mounting area and the accessory standard mounting surface may be planes or revolved surfaces, where the generatrix of a revolved surface may be any suitable line, e.g., a straight line, a curve or a stepped line.

In some embodiments, a 100% match between the contours of the outer surface of the accessory mounting area and the accessory standard mounting surface is not required, it only requires that the matching degree is within a tolerance of a fixation method (namely, as long as the matching degree ensures a certain bonding strength).

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

1. A shell-shaped body of a shell-shaped dental appliance, the shell-shaped body comprising:
a one-piece shell forming a cavity for receiving a plurality of teeth and a first accessory mounting area,
wherein a contour of an outer surface of the first accessory mounting area has a standard geometry for mounting a first accessory having a standard mounting surface, and wherein the contour of the outer surface of the first accessory mounting area substantially matches that of a standard mounting surface of a first accessory.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A shell-shaped dental appliance, comprising:
a shell-shaped body which is a one-piece shell and forms a cavity for receiving a plurality of teeth and a first accessory mounting area; and
a first accessory forming a standard mounting surface;
wherein a contour of a outer surface of the first accessory mounting area substantially matches that of the standard mounting surface of the first accessory, and the first accessory is mounted on the shell-shaped body by bonding the outer surface of the first accessory mounting area and the standard mounting surface.

14. (canceled)

15. (canceled)

16. (canceled)

17. (canceled)

18. (canceled)

19. (canceled)

20. (canceled)

21. (canceled)

22. (canceled)

23. (canceled)

24. The shell-shaped body of claim 1, wherein the first accessory is button, and the first accessory mounting area is for mounting the button by adhesion.

25. The shell-shaped dental appliance of claim 13, wherein the first accessory is button, and the first accessory mounting area is for mounting the button by adhesion.
